(19) United States
(12) Patent Application Publication
(10) Pub. No.: US 2014/0035460 A1
(43) Pub. Date: Feb. 6, 2014

(54) HIGH EFFICIENCY LIGHT BULB

(71) Applicant: Totada` R. Shantha, Stone Mountain, GA (US)

(72) Inventor: Totada` R. Shantha, Stone Mountain, GA (US)

(21) Appl. No.: 13/951,076

(22) Filed: Jul. 25, 2013

(51) Int. Cl. H01J 61/35

(52) U.S. Cl. CPC H01J 61/35
USPC 315/49

(57) ABSTRACT

A high efficiency light bulb has an outer globe with a base and a detachable bulb portion. The base has a base connection portion with a screw base and a control circuit with transformer for controlling and conveying electric power from the screw base to a quartz tungsten filament. The detachable bulb portion has an outer globe and an inner globe. At least the inner globe has a transparent infrared heat reflecting coating to improve efficiency by retaining heat within and reflecting the heat back on the filament. In another embodiment, the bulb and base are not detachable and the whole bulb is replaced when it reaches the end of its usefulness. A non-reactive gas such as krypton, bromine or xenon, for example, is used to fill the bulbs.

### BACKGROUND OF THE INVENTION

Energy conservation has become very important in view of the rising cost of energy in the United States. Historically, energy has been relatively inexpensive in the United States and as a result many energy consuming devices were not required to be energy efficient. Because energy is getting more expensive, there is great interest in using devices that are more energy efficient. Incandescent bulbs have been used since their invention and while producing a pleasing spectrum of light, actually convert a lot of the useful energy into heat rather than light.

Fluorescent lights are newer than incandescent lights, but they have been around for a while and although they are more energy efficient than incandescent lights, they are more suited for industrial use and some people react negatively to the spectrum of light produced. Recently, many people have been switching to compact fluorescent lights (CFL's) and energy companies have been offering rebates to consumers who use them. While CFL's have some advantages over incandescent lights, they too have some limitations which have prevented them from replacing incandescent lights. Recent testing seems to indicate that although CFL's claim extended life over the ordinary incandescent bulb, in typical use where they are switched on and off for short periods of time, their useful life is greatly reduced. Also, the spectrum produced by CFL's is basically the same as ordinary fluorescent lighting and many people react negatively to them. Additionally, CFL's contain a small amount of mercury and this requires the consumer to treat burnt out CFL's as hazardous waste rather than just being able to dispose of them in the trash. Recently, other energy efficient solution are also making their way to the market place such as light emitting diodes (LEDs) and halogen, but high cost is still preventing these technologies from widespread adoption.

Even if the price of CFLs is brought down to the point where the price is no longer prohibitive, the problem of producing light with a more natural solar spectrum has not been solved along with the environmental concerns that are associated with the hazardous waste produced when disposing of them. There is a need for a light source that is both economical and more efficient than a traditional incandescent light bulb but still produces a pleasing spectrum of emitted light.

### SUMMARY OF THE INVENTION

A high efficiency light bulb has an outer globe with a base and a detachable bulb portion. The base has a base connection portion with a screw base and a control circuit with transformer for controlling and conveying electric power from the screw base to a quartz tungsten filament. The detachable bulb portion has an outer globe and an inner globe. At least the inner globe has a transparent infrared heat reflecting coating to improve efficiency by retaining heat within and reflecting the heat back on the filament. In another embodiment, the bulb and base are not detachable and the whole bulb is replaced when it reaches the end of its usefulness. A non-reactive gas such as krypton, bromine or xenon, for example, is used to fill the bulbs.

The present invention is a light bulb that incorporates many of the beneficial properties of both CFL and incandescent bulbs, while minimizing those qualities of each type that are detrimental. The present device contains no mercury, is twice as efficient as a 15 W incandescent bulb, has an average life of at least four times an incandescent bulb while having the color rendition or spectrum similar to that of daylight. The instant high efficiency light bulb is more efficient than an incandescent bulb, providing at least 12 but as high as 24 more lumens per watt. Further, such a device provides a replaceable bulb portion selectively detachable from a base that includes ballast electronics, thereby reducing costs when a replacement bulb is needed. Other features and advantages of the present invention will become apparent from the following more detailed description, taken in conjunction with the accompanying drawings, which illustrate, by way of example, the principles of the invention.

### BRIEF DESCRIPTION OF THE DRAWINGS

Other features and advantages of the instant invention will become apparent from the following description of the invention which refers to the accompanying drawings.

FIG. 1 is a side view of a high efficiency light bulb with replaceable element according to an embodiment of the invention.

FIG. 2 is an exploded side view of the high efficiency light bulb shown in FIG. 1.

FIG. 3 is a bottom view of the globe portion of the high efficiency light bulb shown in FIG. 1.

FIG. 4 a top view of the base portion of the high efficiency light bulb shown in FIG. 1.

FIG. 5 is a cut-away side view showing the control circuitry of the high efficiency light bulb shown in FIG. 1.

FIG. 6 is a side view of a high efficiency light bulb according to an embodiment of the invention.

FIG. 7 is a cut-away side view of the high efficiency light bulb shown in FIG. 1 with a reflector.

FIG. 8 is a circuit diagram of a typical control circuit.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

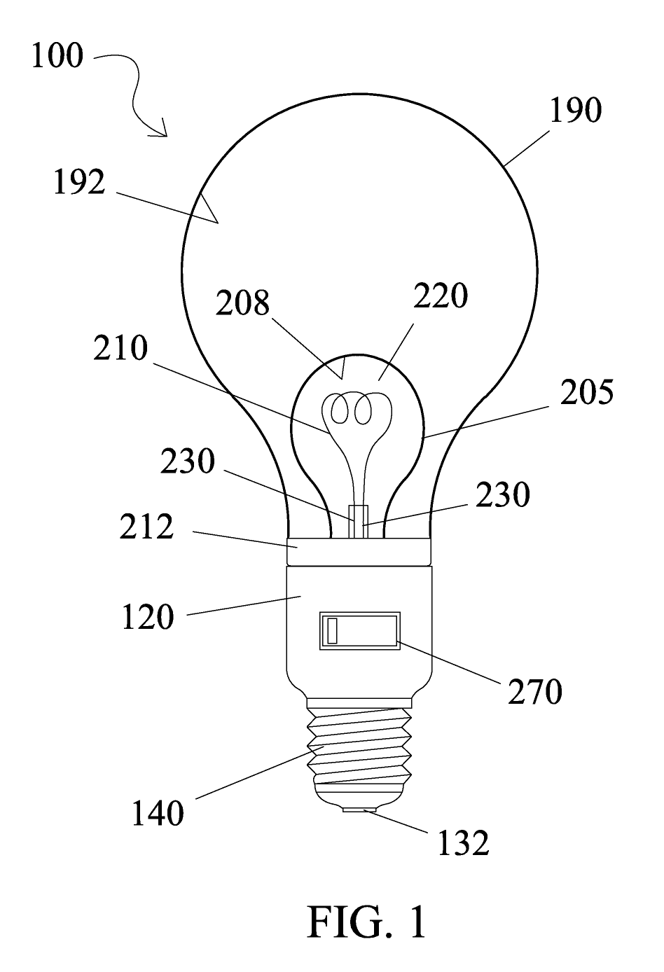

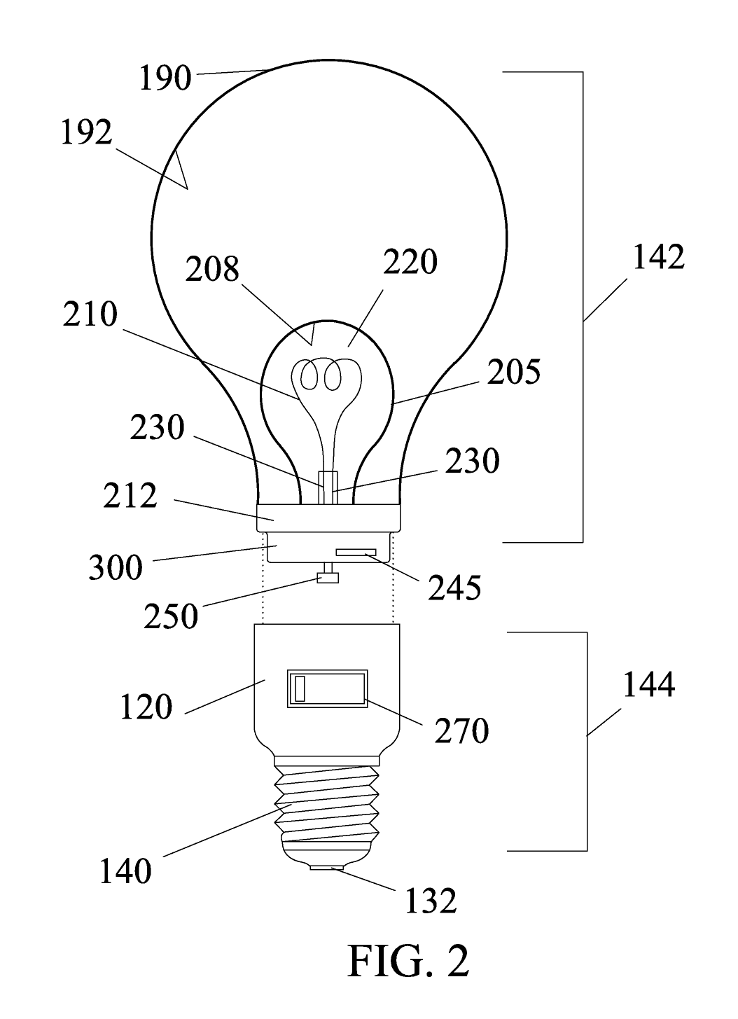

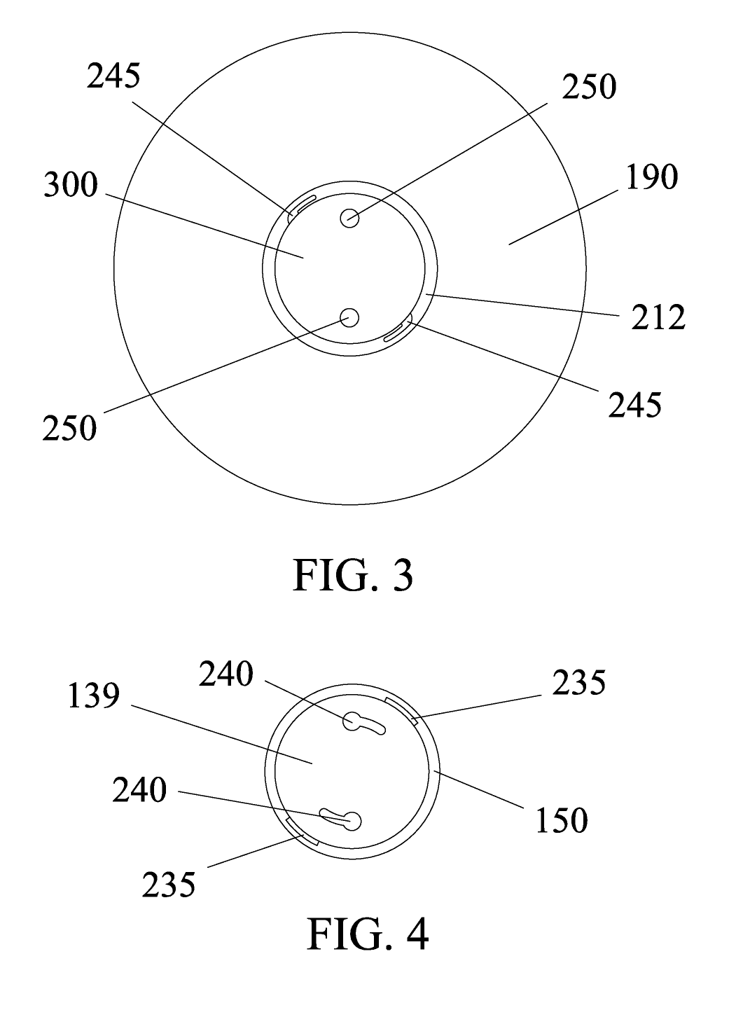

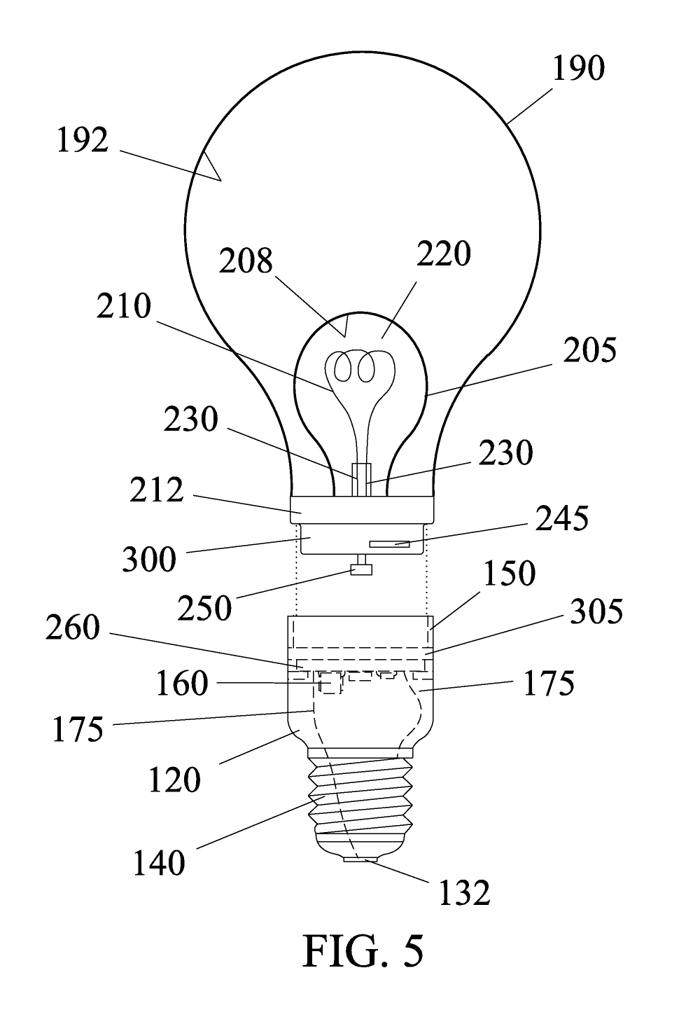

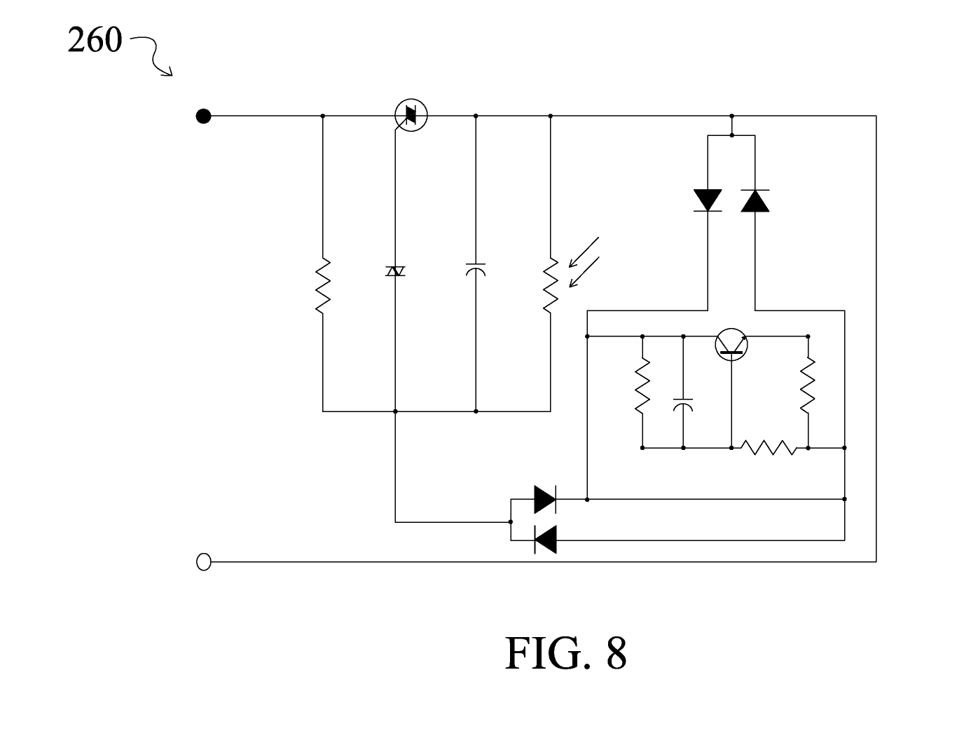

Referring to FIGS. 1-5 and 8, a high efficiency light bulb with replaceable element 100 is shown having an outer globe 190 with an inner globe 205. A filament 210 is contained within inner globe 205 and is electrically connected with wires 230. A collar 212 joins and seals the globes and fits with base connection portion 150. Filament 210 is a quartz encased tungsten filament to improve filament function; however, other filaments may be used. Base 120 has a screw base portion 140 with an electrical contact 132 at the bottom. In the embodiment shown, a switch 270 is provided to switch between a “high” and “low” position. Of course, it should be understood that a high efficiency light bulb 100 does not require switch 270.

Base 120 includes a base connector portion 150 at an upper end thereof which has a hollow portion to receive a lower portion of bulb portion 142. Base 120 also houses a control circuit 260 which controls and conveys the electric power from screw base 140 to filament 210. Control circuit includes a voltage step-down transformer 160, which may be a two-step transformer that is selectively set to one of two output voltages, such as 9 V and 12 V, with switch 270 on base 120. The two output voltages correspond to a “dim” and a “bright” setting for light intensity of high efficiency light bulb 100.

A base heat insulator 305 is provided in base 120 to thermally insulate control circuit 260 from the heat generated in operation. Wires 175 are used to electrically connect screw base 140 and electrical contact 132 with control circuit 260 which in turns energizes filament 210. Screw base 140 is preferably a screw-type that fits in a standard screw style electrical socket (not shown). Alternatively the screw base 140 may be a bayonet-type cap for placement in a bayonet-style electrical socket or any other suitable socket as is known in the art.

A bulb portion 144 includes an outer globe 190 which encloses a non-opaque inner globe 205. Inner globe 205 is filled with a non-reactive gas 220, such as a mixture of any or all of the following gases: Krypton, Bromine, or Xenon, for example. A globe heat insulator 300 offers additional thermal protection to control circuit 260. Both base heat insulator 305 and globe heat insulator 300 are made of silicon which has excellent insulating properties. Of course any suitable insulting material may be used. To increase the efficiency of filament 210, a substantially transparent infrared (IR) heat reflective coating 208 is applied to an inner surface of inner globe 205 to retain the heat energy produced by filament 210. Additionally, a similar transparent IR coating 192 may be applied to an inner surface of outer globe 190 to further enhance efficiency.

The IR coatings are made of heat reflective coatings that are reflective to long-wave IR radiation and operate as heat mirrors reflecting much of the heat back towards filament 210. Any suitable IR coating may be used such as, but not limited to Ytterbium Fluoride, Au, Nano-oxides, Titanium Di-oxide, and combinations of these to tune the reflectiveness to maximize the IR reflectivity. The coating may be applied by thin film deposition methods such as sputtering, vacuum evaporation, e-beam deposition, brushing, spraying, etc. as long as a transparent IR reflecting coating 208 is reliably applied to inside surface of inner globe 205. To further enhance the thermal properties, a transparent layer of non-flammable silicone may be applied over IR coating 208 to protect and trap heat therein.

In one embodiment of the invention, base 120 includes a pair of keyhole slots 240 in a top surface 139 of base 120. A pair of cooperating T-shaped conductors 250 fit within keyhole slots 240 and are then twisted with respect to base 120 to couple bulb portion 340 to base 120 both mechanically and electrically. A pair of locking tabs 245 are connected to color 212 and twistingly interlock with tab slots 235 disposed in base connection portion.

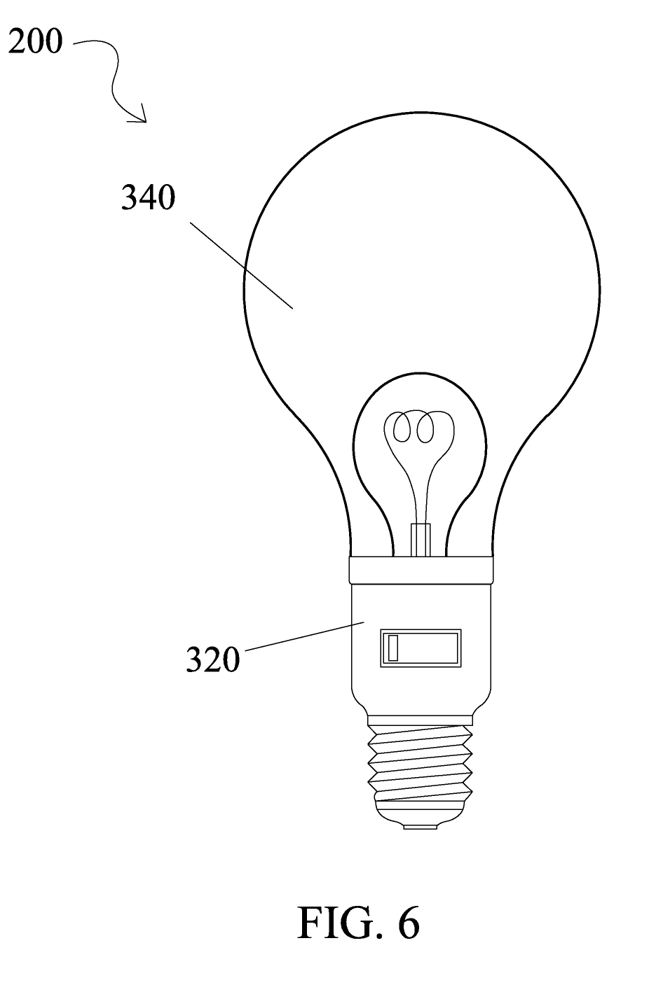

Now referring to FIG. 6, an energy efficient light bulb 200 is shown having a base portion 320 and a bulb portion 340. In this embodiment, base portion 320 is not removable from globe portion 340. Again as discussed above, an IR coating is applied to the inside of at least the inner bulb to reflect heat energy back towards the filament.

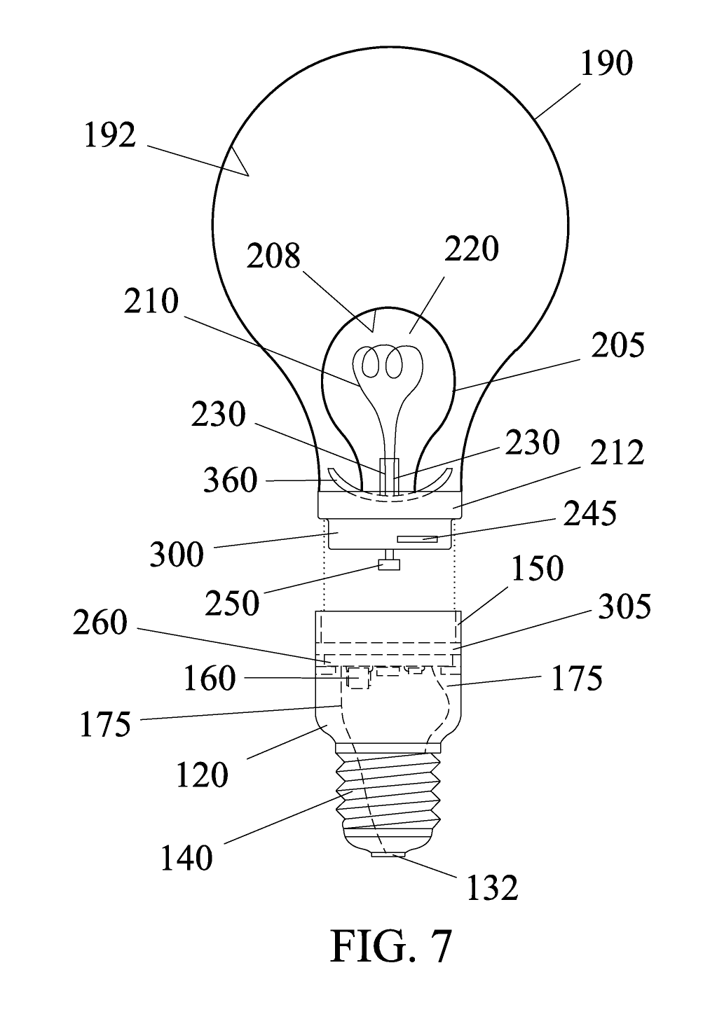

Referring to FIG. 7, a reflector 360 is provided at the base of inner globe 205 to reflect heat energy back towards inner globe 205 to further enhance efficiency and to further isolate base 120 from the heat generated in operation.

The results of a comparison of high efficiency light bulb with prior art light sources are shown below in table 1.

TABLE 1
Comparison of High Efficiency Light with Prior Art

| | Standard | Standard Compact | |
|---|---|---|---|
| | Incandescent* | Fluorescent | High Efficiency |
| Power Consumption (Watts) | 75 | 22 | 37 |
| Brightness (Lumens) | 900 | 880 | 900 |
| Efficiency (Lumens/Watt) | 12 | 40 | 24 |
| Bulb Life (hours) | 1000 | 8000 | 4000 at high |
| | | | setting 40,000 at |
| | | | low setting |
| Suggested Price (dollars) | $1.00 | $6-8 | $1.95 |
| Electricity Consumed (yearly in kWH) | 273 | 80.3 | 135.05 |
| Yearly Savings (dollars) | N/A | $23.21 | $16.64 |
| Economic Recovery Period | N/A | 7 to 13 months | 1.5 to 4 months |
| Advantages and Disadvantages | High energy use | Low energy use | Low energy use |
| | | Undesirable color | Natural colored |
| | | rendition | light |
| | | No natural colored | |
| | | light | |
| Environmental pollution | Landfill pollution | Hazardous waste of | No hazardous |
| | | mercury | mercury |
| | | | pollution |
| Comparison of heat output | Very high heat | Low heat output | Low heat output |
| | output | Phosphorus radiation | No phosphorus |
| | | | radiation |

Although the instant invention has been described in relation to particular embodiments thereof, many other variations and modifications and other uses will become apparent to those skilled in the art.

What is claimed is:

1. An energy efficient light bulb comprising:
a base;
said base having a screw base adapted to fit within a screw socket;
an outer globe portion disposed on an other end of said base;
an inner globe disposed within said outer globe;
a filament disposed within said inner globe;
a control circuit disposed within an upper portion of said base;
said filament in electrical communication with said control circuit; and
a transparent IR reflective coating disposed on an inner surface of said inner globe.

2. The energy efficient light bulb of claim 1 wherein said transparent thermal coating is titanium dioxide.

3. The energy efficient light bulb of claim 1 wherein said transparent thermal coating is Ytterbium Fluoride.

4. The energy efficient light bulb of claim 1 wherein said transparent thermal coating is a nano-oxide.

5. The energy efficient light bulb of claim 1 further comprising a transparent thermal non-flammable silicone coating disposed over said IR coating.

6. The energy efficient light bulb of claim 1 further comprising a second transparent IR coating disposed on an inside portion of said outer globe.

7. The energy efficient light bulb of claim 1 wherein said control circuit includes a voltage transformer.

8. An energy efficient light bulb comprising:
a base having a screw base at a lower end thereof and a base connection portion at an upper end thereof,
a control circuit disposed within said base;
an outer globe;
an inner globe disposed within said outer globe;
a filament disposed within said inner globe;
said filament being in electrical contact with said control circuit whereby said filament is energized;
a collar;
said outer and inner globes attached to said collar;
said collar adapted to removably fit within said base connection portion;
said base having a socket portion wherein said socket portion adapted to fit within a bulb socket;
a transparent IR coating disposed on an inner surface of said inner globe; and
an inert gas disposed within said inner globe.

9. The energy efficient light bulb of claim 5 wherein said screw base is a screw-type cap for placement in a screw style electrical socket.

10. The energy efficient light bulb of claim 5 wherein said screw base is a bayonet-type cap for placement in a bayonet-style electrical socket.

11. The energy efficient light bulb of claim 5 wherein said control circuit includes an electric voltage stepdown transformer.

12. The energy efficient light bulb of claim 5 further comprising a reflector disposed on a lower portion of said filament wherein light produced is directed towards said filament and away from base.

13. The energy efficient light bulb of claim of claim 5 wherein the non-reactive gas is a mixture taken from the set of gases consisting of: Krypton, Bromine, and Xenon.
